(19) United States
(12) Patent Application Publication
(10) Pub. No.: US 2018/0066593 A1
(43) Pub. Date: Mar. 8, 2018

(54) Control Device for Internal Combustion Engine and Abnormal Combustion Detecting Method

(71) Applicant: Hitachi Automotive Systems, Ltd., Hitachinaka-shi, ibaraki (JP)

(72) Inventors: Shouichirou UEZONO, Isesaki-shi (JP); Koji MATSUFUJI, Isesaki-shi (JP)

(73) Assignee: Hitachi Automotive Systems, Ltd., Hitachinaka-shi, Ibaraki (JP)

(21) Appl. No.: 15/557,619

(22) PCT Filed: Mar. 7, 2016
(86) PCT No.: PCT/JP2016/056985

§ 371 Date: Sep. 12, 2017

(30) Foreign Application Priority Data
Mar. 13, 2015 (JP) 2015-050678

(51) Int. Cl. F02D 35/02; G01L 23/22

(52) U.S. Cl. CPC F02D 35/027; F02D 35/023; G01L 23/221

(57) ABSTRACT

There are provided a control device and an abnormal combustion detecting method for detecting occurrence of abnormal combustion during an expansion stroke of an internal combustion engine. The control device of the present invention receives a detection signal of a vibration sensor for detecting pressure vibration in a combustion chamber, and detects occurrence of knocking based on a knocking-specific frequency component extracted from the detection signal in a knocking determination region within the expansion stroke. In addition, the control device detects the characteristic value, different from the knocking-specific frequency component, of the detection signal in an abnormal combustion determination region which includes the knocking determination region and which expands over the compression stroke before ignition timing and the expansion stroke, and detects self-ignition during the compression stroke before ignition timing and self-ignition during the expansion stroke, based on the characteristic value.

### TECHNICAL FIELD

The present invention relates to a control device for an internal combustion engine and to an abnormal combustion detecting method, and particularly relates to a technique for detecting knocking and abnormal combustion from a detection signal of a vibration sensor for detecting pressure vibration in combustion chambers of a spark ignition internal combustion engine.

### BACKGROUND ART

Patent Document 1 discloses an abnormal combustion detection device capable of identifying the type of abnormal combustion from an abnormal combustion signal output from a vibration sensor even if the amplitude of the abnormal combustion signal does not vary much depending on what type of abnormal combustion is indicated thereby. To this end, a threshold value for identifying a preignition in a preignition detection section is set to a value above noise level in a section earlier than the TDC, and set to a value above a level that can typically correspond to knocking in a section later than the TDC. Thereby, the abnormal combustion detection device identifies abnormal combustion as preignition when the peak of the abnormal combustion is at the angle corresponding to an early timing even if the peak is low.

### REFERENCE DOCUMENT LIST

### Patent Document

Patent Document 1: JP 2013-160200 A

### SUMMARY OF THE INVENTION

### Problems to be Solved by the Invention

In recent years, the compression ratio of a spark ignition internal combustion engine has tended to increase, and thus, preignition has tended to occur more often.

Preignition (self-ignition during the compression stroke) is a kind of abnormal combustion in which a fuel-air mixture is self-ignited during the compression stroke before being spark-ignited by a spark plug. Self-ignition during the compression stroke is initiated by a heat source such as an overheated spark plug, carbon sludge accumulated in the corresponding combustion chamber, and oil falling in drops. Furthermore, self-ignition (abnormal combustion) may possibly occur even during the expansion stroke by a mechanism similar to that which causes preignition.

Self-ignition at a relatively low level does not immediately damage the internal combustion engine. However, when such self-ignition occurs repeatedly, damage accumulates in the internal combustion engine. To avoid this, it is desirable to detect self-ignition during the expansion stroke by distinguishing such self-ignition from knocking, and to implement an appropriate countermeasure to the self-ignition.

The present invention has been made in consideration of the problems, and an object thereof is to provide a control device for an internal combustion engine and an abnormal combustion detecting method which are capable of detecting occurrence of abnormal combustion during the expansion stroke by distinguishing such abnormal combustion from knocking.

### Means for Solving the Problems

To this end, according to the present invention, there is provided a control device for an internal combustion engine which receives a detection signal of a vibration sensor for detecting pressure vibration in a combustion chamber of a spark ignition internal combustion engine, detects occurrence of knocking based on a knocking-specific frequency component of the detection signal in a knocking determination region, and detects occurrence of abnormal combustion based on a characteristic value, different from the knocking-specific frequency component, of the detection signal in an abnormal combustion determination region including the knocking determination region.

In addition, according to the present invention, there is provided an abnormal combustion detecting method for an internal combustion engine including: receiving a detection signal of a vibration sensor for detecting pressure vibration in a combustion chamber of a spark ignition internal combustion engine; extracting a knocking-specific frequency component from the detection signal in a knocking determination region within an expansion stroke; detecting occurrence of knocking based on the knocking-specific frequency component; detecting a characteristic value, different from the knocking-specific frequency component, of the detection signal in an abnormal combustion determination region including the knocking determination region that extends over a compression stroke before ignition timing and the expansion stroke; and detecting, as abnormal combustion, self-ignition during the compression stroke before ignition timing and self-ignition during the expansion stroke, based on the characteristic value.

### Effects of the Invention

According to the present invention described above, it is possible to detect occurrence of abnormal combustion during an expansion stroke by distinguishing such abnormal combustion from knocking, thus allowing implementing an appropriate countermeasure to rapidly correct abnormal combustion when the abnormal combustion occurs during the expansion stroke.

### BRIEF DESCRIPTION OF THE DRAWINGS

FIG. 1 is a system view of an internal combustion engine according to an embodiment of the present invention.

FIG. 2 is a diagram illustrating a difference in frequency characteristics between knocking and self-ignition according to an embodiment of the present invention.

FIG. 3 is a functional block diagram for detecting self-ignition and knocking through frequency analysis according to an embodiment of the present invention.

FIG. 4 is a view illustrating a sensing window for performing frequency analysis according to an embodiment of the present invention.

FIG. 5 is a view illustrating countermeasure processing for self-ignition and knocking according to an embodiment of the present invention.

FIG. 6 is a view for describing overlapping of sensing windows during high engine rotation according to an embodiment of the present invention.

FIG. 7 is a view illustrating a sensing window for detecting knocking through frequency analysis and a region for detecting self-ignition based on a voltage level according to an embodiment of the present invention.

FIG. 8 is a functional block diagram for detecting knocking through frequency analysis and detecting self-ignition based on a voltage level according to an embodiment of the present invention.

FIG. 9 is a diagram for describing learning for reducing the sensing window according to an embodiment of the present invention.

### MODES FOR CARRYING OUT THE INVENTION

Embodiments of the present invention will be described below with reference to the drawings.

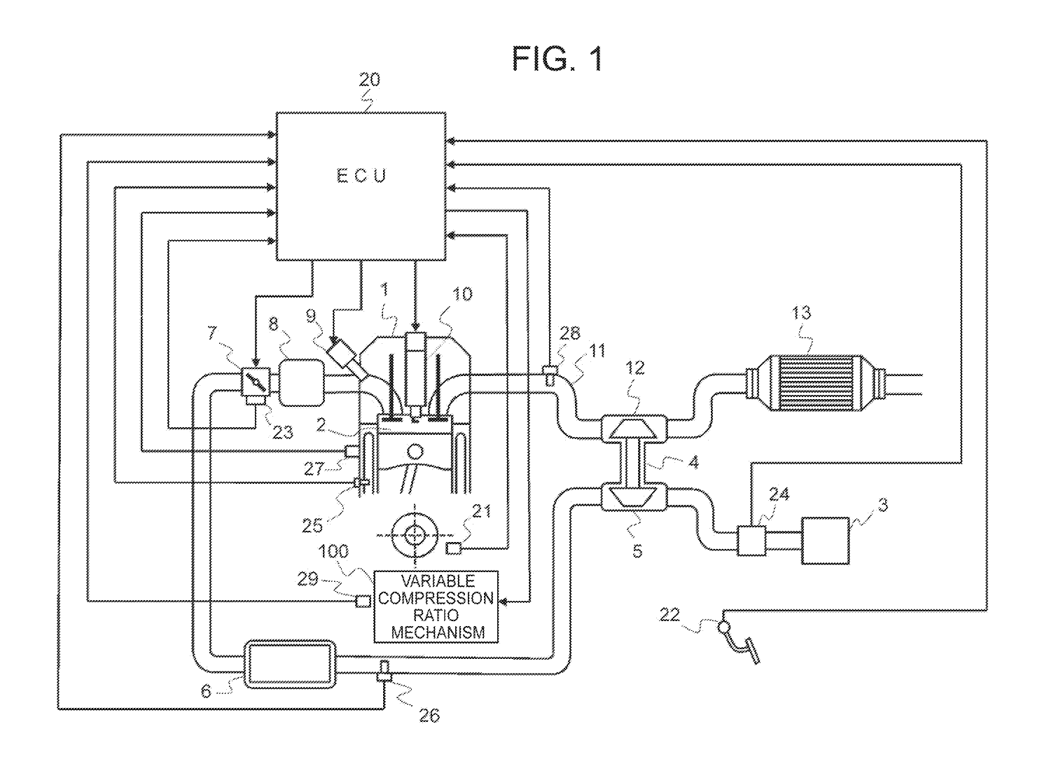

FIG. 1 is a system schematic view illustrating an example of an internal combustion engine in which a control device and an abnormal combustion detecting method according to an embodiment of the present invention are employed.

An internal combustion engine 1 of FIG. 1 is a spark ignition type multi-cylinder four-cycle engine mounted in a vehicle and used as a power source for the vehicle.

Air is drawn from an air cleaner 3 into a combustion chamber 2 of each of the cylinders of internal combustion engine 1 via an intake air compressor 5 of a supercharger 4, an intercooler 6, an electrically controlled throttle valve 7, and an air intake manifold 8.

Fuel injection valves 9 are provided respectively for the cylinders in branch portions of air intake manifold 8. Based on an injection pulse signal, each fuel injection valve 9 opens and ejects fuel into an air intake port of the corresponding cylinder with a pressure adjusted to a predetermined pressure.

The fuel drawn into combustion chamber 2 is spark-ignited by a spark plug 10 and combusted. Alternatively, an in-cylinder injection type internal combustion engine including fuel injection valves that directly inject fuel into combustion chambers 2 may be employed.

Exhaust produced by combustion is discharged through an exhaust manifold 11, an exhaust turbine 12 of supercharger 4, and an exhaust cleaning catalyst 13.

The operations of electrically controlled throttle valve 7, fuel injection valves 9, and spark plugs 10 are controlled by an engine control unit (hereinafter, referred to as ECU) 20, which internally includes a microcomputer.

In order to perform the above control, ECU 20 receives detection signals output from various sensors.

Various sensors include a crank angle sensor 21, an accelerator opening sensor 22, a throttle opening sensor 23, an airflow sensor 24, a water temperature sensor 25, an intake air temperature sensor 26, a vibration sensor 27, a wide-area air-fuel ratio sensor 28, and the like. Crank angle sensor 21 generates a crank angle signal POS synchronized with engine rotation. Accelerator opening sensor 22 detects an accelerator opening (how far an accelerator pedal is pressed) APO. Throttle opening sensor 23 detects an opening TVO of electrically controlled throttle valve 7. Airflow sensor 24 detects an intake air flow rate QA. Water temperature sensor 25 detects a cooling water temperature TW in internal combustion engine 1. Intake air temperature sensor 26 detects an intake air temperature TA. Vibration sensor 27 indirectly detects vibration of a cylinder block by detecting pressure vibration in the combustion chambers. Wide-area air-fuel ratio sensor 28 linearly detects an air-fuel ratio of fuel-air mixture for combustion according to an oxygen concentration in exhaust.

For example, vibration sensor 27 is a non-resonant sensor which uses piezoelectric ceramics for vibration detection.

ECU 20 sets a target throttle opening TGTVO based on the accelerator opening APO, and controls the opening of electrically controlled throttle valve 7 so as to achieve the target throttle opening TGTVO.

In addition, ECU 20 controls fuel injection as follows: First, ECU 20 calculates a basic fuel injection pulse width TP from the intake air flow rate QA and an engine rotation speed NE. Then, ECU 20 calculates a final fuel injection pulse width TI by correcting the basic fuel injection pulse width TP with various correction coefficients COEF calculated based on the cooling water temperature TW, the air-fuel ratio, and the like. Finally, ECU 20 outputs a fuel injection pulse signal having this pulse width TI to each fuel injection valve 9 at a timing predetermined for each of the cylinders so as to cause fuel injection valve 9 to inject fuel at that timing.

In addition, ECU 20 controls ignition operation as follows. First, ECU 20 sets a basic ignition timing MADV mainly based on the engine rotation speed NE and an engine load TE (for example, the intake air flow rate QA, the basic fuel injection pulse width TP, the accelerator opening APO, the throttle opening TVO and the like). Then, ECU 20 sets a final ignition timing ADV by correcting the basic ignition timing MADV in accordance with a combustion state and the like, and causes spark plug 10 to perform ignition operation at this ignition timing ADV.

Furthermore, internal combustion engine 1 includes a variable compression ratio mechanism 100, which is capable of changing a mechanical compression ratio by, for example, changing the top dead center position of pistons.

ECU 20 sets a target compression ratio mainly based on the engine rotation speed NE and the engine load TE, and controls an actuator (such as a motor) for variable compression ratio mechanism 100 based on an output from an operation variable sensor 29 such that an actual compression ratio becomes the target compression ratio.

In addition, ECU 20 detects knocking based on the detection signal of vibration sensor 27, and detects self-ignition during a compression stroke (preignition) and self-ignition during an expansion stroke based on the detection signal of vibration sensor 27. In other words, ECU 20 has a software-based function to serve as a detection unit for detecting knocking and self-ignition (abnormal combustion) based on the detection signal of vibration sensor 27.

Furthermore, ECU 20 has a software-based function to serve as an abnormality countermeasure unit for correcting knocking and self-ignition. Specifically, ECU 20 corrects knocking by performing processing such as correction for retarding ignition timing, when detecting occurrence of the knocking. ECU 20 corrects self-ignition by increasing the fuel injection amount or by performing fuel cut-off (stopping fuel injection), when detecting occurrence of the self-ignition.

Here, self-ignition during the compression stroke (preignition) is a kind of abnormal combustion in which a fuel-air mixture is self-ignited during the compression stroke before being spark-ignited by spark plug 10. Self-ignition during the compression stroke is initiated by a heat source such as overheated spark plug 10, carbon sludge accumulated in combustion chamber 2, and oil falling in drops. Similarly, self-ignition during the expansion stroke is also a kind of abnormal combustion in which a fuel-air mixture is self-ignited by a heat source such as carbon sludge and oil falling in drops.

On the other hand, knocking is a phenomenon in which internal combustion engine 1 produces metallic sounds or vibrations. Both self-ignition during the compression stroke and self-ignition during the expansion stroke are phenomena different from knocking, and are not included in knocking.

ECU 20 detects occurrence of knocking as follows: First, ECU 20 periodically A/D converts the detection signal (analog voltage signal) of vibration sensor 27 and retrieves the resultant voltage data. Then, ECU 20 extracts a knocking-specific frequency component from the thus-retrieved voltage data by frequency-analyzing the voltage data through a fast Fourier transform (FFT) or the like, and detects that knocking has occurred when the magnitude of the knocking-specific frequency component exceeds a first threshold value.

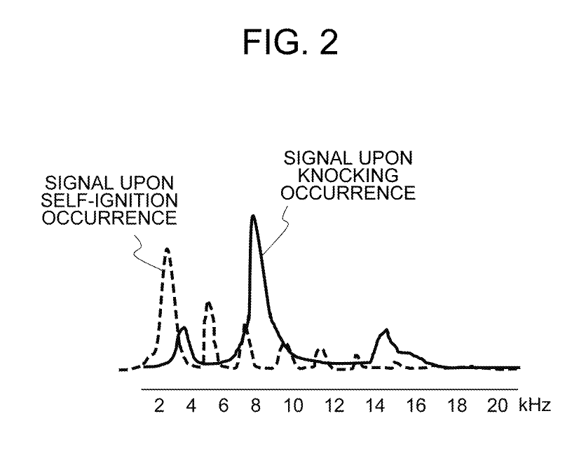

Here, self-ignition during the expansion stroke sometimes occurs in a region where knocking can also occur. However, as illustrated in FIG. 2, the frequency range of the knocking-specific frequency component differs from that of the self-ignition-specific (abnormal combustion-specific) frequency component. Thus, identifying the magnitude of the knocking-specific frequency component makes it possible to avoid falsely detecting self-ignition during the expansion stroke as knocking.

Here, the knocking-specific frequency component is around 7 kHz, for example. The self-ignition-specific (abnormal combustion-specific) frequency component is around 2 kHz, for example.

Similarly to the detection of knocking, ECU 20 detects self-ignition during the compression stroke and self-ignition during the expansion stroke through frequency analysis of the detection signal of vibration sensor 27.

In other words, ECU 20 detects occurrence of self-ignition as follows. First, ECU 20 periodically A/D converts the detection signal (voltage signal) of vibration sensor 27 and retrieves the resultant voltage data. Then, ECU 20 extracts a self-ignition-specific frequency component from the thus-retrieved voltage data by frequency-analyzing the voltage data through a fast Fourier transform (FFT) or the like, and detects that self-ignition has occurred when the magnitude of the self-ignition-specific frequency component exceeds a second threshold value.

When the timing of such self-ignition detection is before ignition timing, ECU 20 detects that self-ignition during the compression stroke (preignition) has occurred. On the other hand, when the timing of such self-ignition detection is after ignition timing, ECU 20 detects that self-ignition during the expansion stroke has occurred.

In this manner, ECU 20 detects the presence or absence of knocking based on the knocking-specific frequency component, while detecting self-ignition during the compression stroke and self-ignition of the expansion stroke based on the self-ignition-specific frequency component which is a characteristic value, different from the knocking-specific frequency component, of the detection signal.

As described above, since the frequency range of the knocking-specific frequency component differs from that of the self-ignition-specific frequency component, identifying the magnitude of the self-ignition-specific frequency component makes it possible to avoid falsely detecting knocking as self-ignition during the expansion stroke.

In this manner, based on the frequency analysis result of the detection signal of vibration sensor 27, ECU 20 individually detects and distinguishes between self-ignition during the compression stroke, self-ignition during the expansion stroke, and knocking.

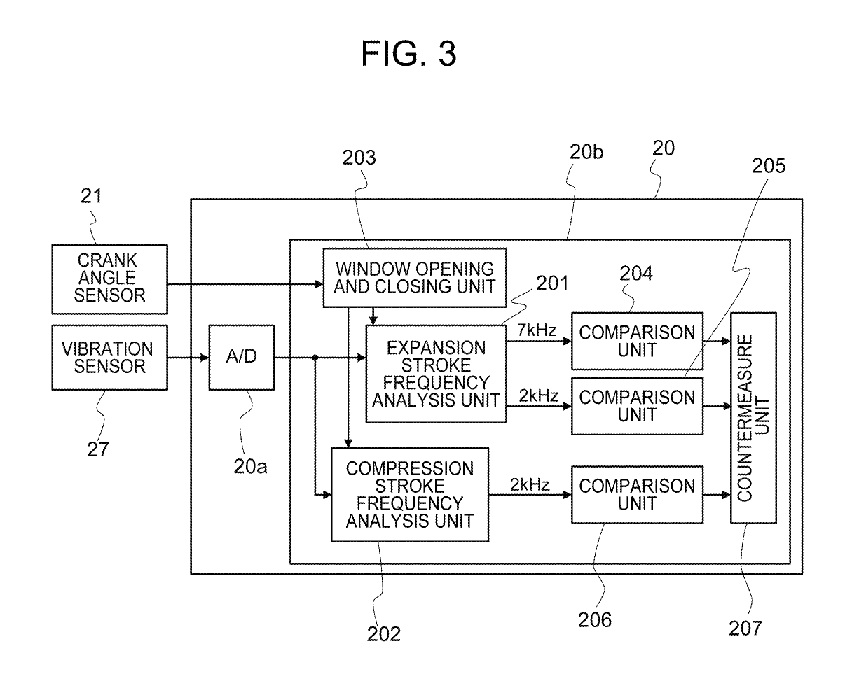

FIG. 3 is a functional block diagram of ECU 20 which detects self-ignition and knocking through frequency analysis.

The detection signal (voltage signal) of vibration sensor 27 is converted to digital data by an A/D converter 20a internally included in ECU 20, and the digital data is retrieved by a microcomputer (CPU) 20b internally included in ECU 20.

Microcomputer 20b includes frequency analysis units which performs frequency analysis on output data from A/D converter 20a. Specifically, microcomputer 20b includes an expansion stroke frequency analysis unit 201 which performs frequency analysis in a sensing window of the expansion stroke, and a compression stroke frequency analysis unit 202 which performs frequency analysis in a sensing window of the compression stroke. Furthermore, microcomputer 20b also includes a sensing window opening and closing unit 203 which opens and closes the sensing windows for both of frequency analysis units 201 and 202 based on the output from crank angle sensor 21.

Expansion stroke frequency analysis unit 201 extracts and outputs the knocking-specific frequency component (component of 7 kHz) and the self-ignition-specific frequency component (component of 2 kHz). A first comparison unit (knocking detection unit) 204 compares the knocking-specific frequency component with the first threshold value, and outputs a signal indicating the presence or absence of knocking. A second comparison unit (expansion stroke self-ignition detection unit) 205 compares the self-ignition-specific frequency component with the second threshold value, and outputs a signal indicating the presence or absence of self-ignition during the expansion stroke.

Compression stroke frequency analysis unit 202 extracts and outputs the self-ignition-specific frequency component. A third comparison unit (compression stroke self-ignition detection unit, or preignition detection unit) 206 compares the self-ignition-specific frequency component (component of 2 kHz) with the second threshold value, and outputs a signal indicating the presence or absence of self-ignition during the compression stroke (preignition).

The outputs from comparison units 204, 205, and 206 are input to a countermeasure unit 207. Depending on the presence or absence of knocking and the presence or absence of self-ignition, countermeasure unit 207 implements a countermeasure against knocking (retarding ignition timing) and/or a countermeasure against self-ignition (increasing fuel injection amount, performing fuel cut-off).

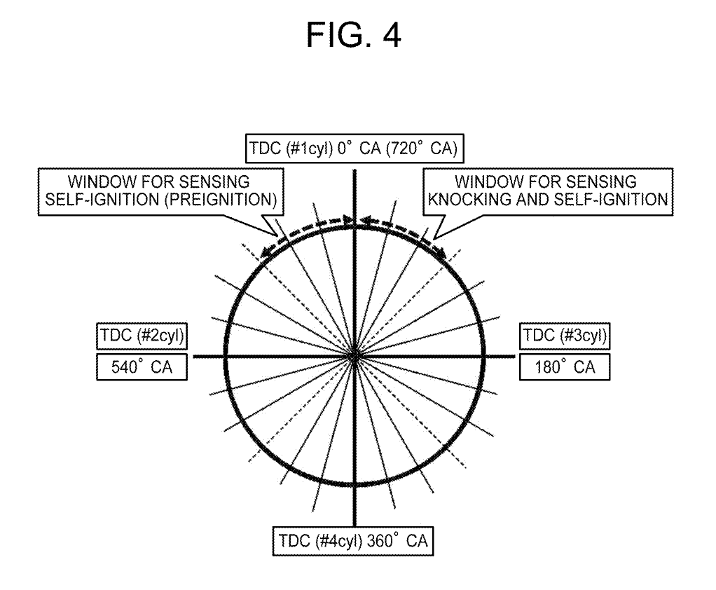

FIG. 4 is a view illustrating the sensing windows in a configuration of using frequency analysis to detect self-ignition during the compression stroke, self-ignition during the expansion stroke, and knocking. In FIG. 4, internal combustion engine 1 is a four-cylinder engine as an example.

As illustrated in FIG. 4, ECU 20 sets a sensing window for preignition during the compression stroke (self-ignition during the compression stroke) to a region of 90 degrees by a crank angle immediately before the compression top dead center TDC (BTDC 90 degrees to TDC). In addition, ECU 20 sets a sensing window for self-ignition and knocking during the expansion stroke to a region of 90 degrees by a crank angle immediately after the compression top dead center TDC (TDC to ATDC 90 degrees).

Sensing window opening and closing unit 203 controls the opening and closing of the sensing windows so as to cause frequency analysis units 201 and 202 to perform frequency analysis in the sensing windows illustrated in FIG. 4.

In other words, a determination region for self-ignition (abnormal combustion) includes the sensing window of the compression stroke and the sensing window of the expansion stroke, so as to extend over the compression stroke before ignition timing and the expansion stroke, and include a determination region for knocking. In this self-ignition determination region, self-ignition during the compression stroke (preignition) is detected, and self-ignition in the knocking determination region, which is distinguished from knocking, is also detected.

In addition, according to the sensing windows illustrated in FIG. 4, the sensing windows for each of the cylinders in the four-cylinder engine having an ignition interval of 180 degrees by the crank angle are provided such that the sensing windows of one cylinder do not overlap those of another cylinder. In other words, the sensing windows are provided such that the sensing window of the compression stroke of one cylinder does not overlap the sensing window of the expansion stroke of another cylinder, and such that the sensing window of the expansion stroke of one cylinder does not overlap the sensing window of the compression stroke of another cylinder. Accordingly, sensing window opening and closing unit 203 opens and closes the sensing windows for each cylinder one by one.

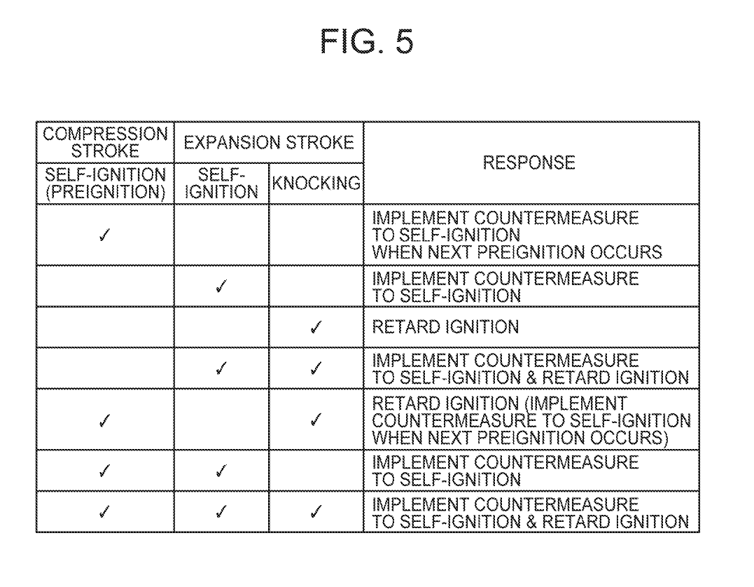

FIG. 5 illustrates an example of countermeasure processing performed by ECU 20 (processing details performed by countermeasure unit 207) upon occurrence of at least one of self-ignition during the compression stroke, self-ignition during the expansion stroke, and knocking.

As illustrated in FIG. 5, ECU 20 selects a countermeasure pattern depending on occurrence status of a combination of at least one of self-ignition during the compression stroke, self-ignition during the expansion stroke, and knocking.

When self-ignition (preignition) occurs during the compression stroke, whereas no knocking or no self-ignition occurs during the expansion stroke, ECU 20 establishes settings for implementing a countermeasure to self-ignition for when the next preignition occurs.

Such countermeasures to self-ignition implemented by ECU 20 may include increasing the fuel injection amount, performing fuel cut-off, decreasing the compression ratio, and the like. These countermeasures allow prevention or reduction of a temperature increase in the combustion chamber, and thus allow prevention or reduction of occurrence of self-ignition.

When self-ignition occurs during the expansion stroke, whereas no knocking or no self-ignition occurs during the compression stroke, ECU 20 implements the countermeasure to self-ignition.

When self-ignition and knocking occur during the expansion stroke, whereas no self-ignition occurs during the compression stroke, ECU 20 implements the countermeasure to self-ignition as well as a countermeasure to knocking. Such countermeasures to knocking implemented by ECU 20 may include performing correction for retarding ignition timing, decreasing the compression ratio, decreasing the boost, and the like.

As described above, ECU 20 detects and distinguishes between self-ignition during the expansion stroke and knocking. This makes it possible for ECU 20 to implement the countermeasure to self-ignition in parallel with the countermeasure to knocking when both self-ignition and knocking occur during the expansion stroke, thus preventing delay in implementing the countermeasure to self-ignition during the expansion stroke or the countermeasure to knocking.

When self-ignition occurs during the compression stroke and knocking occurs during the expansion stroke whereas no self-ignition occurs during the expansion stroke, ECU 20 implements the countermeasure to knocking, as well as establishes the setting for implementing the countermeasure to self-ignition for when the next preignition occurs.

When self-ignition occurs during the compression stroke and self-ignition also occurs during the expansion stroke, whereas no knocking occurs, ECU 20 implements the countermeasure to self-ignition.

When self-ignition occurs during the compression stroke, and self-ignition and knocking occur during the expansion stroke, ECU 20 implements the countermeasure to self-ignition and the countermeasure to the knocking.

Here, when implementing the countermeasure to self-ignition, ECU 20 may implement different types of countermeasure processing depending on the scale of the self-ignition (the magnitude of the self-ignition-specific frequency component).

For example, ECU 20 may increase the fuel injection amount when the self-ignition is small in scale (the vibration signal level is equal to or less than a predetermined value OS1). ECU 20 may perform fuel cut-off when the self-ignition is medium in scale (the vibration signal level is more than the predetermined value OS1 and less than a predetermined value OS2 (OS1<OS2). ECU 20 may perform fuel cut-off without waiting for the next occurrence of preignition when the self-ignition is large in scale (the vibration signal level is equal to or greater than the predetermined value OS2).

Here, it requires a certain length of time to perform a predetermined number of rounds of extracting a predetermined frequency component through frequency analysis. In this regard, when the rotation speed of internal combustion engine 1 increases with the A/D conversion period set constant, the crank angle which corresponds to this certain length of time increases. This sometimes creates a need for expanding the sensing window from 90 degrees of the crank angle.

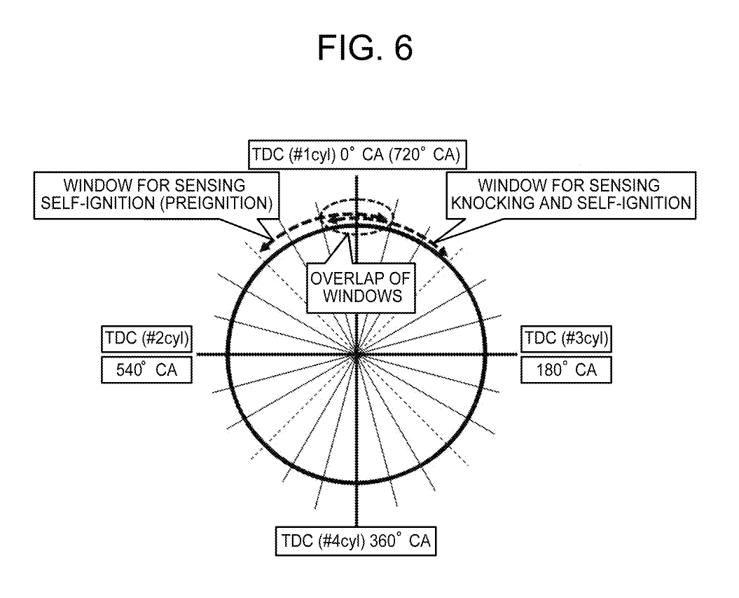

When such a need arises, the sensing window of the compression stroke is expanded across the top dead center so as to extend to the expansion stroke, and the sensing window of the expansion stroke is expanded across the top dead center so as to extend to the compression stroke, as illustrated in FIG. 6. This allows both of these sensing windows of each cylinder to stay within the compression stroke and the expansion stroke of the cylinder, thus ensuring that the sensing windows of one cylinder do not overlap those of another cylinder.

However, expanding the sensing windows as illustrated in FIG. 6 causes ECU 20 to perform frequency analysis simultaneously on two subjects and thus increases a calculation load on ECU 20 in the overlapping region of these sensing windows.

To address this, ECU 20 may be configured to operate as follows when the rotation speed of internal combustion engine 1 becomes equal to or greater than a predetermined value, and when, as a result, the sensing window of the compression stroke and the sensing window of the expansion stroke overlap each other. For example, in the overlapping region of these sensing windows (overlap region), ECU 20 may use the result of frequency analysis during the compression stroke also for detection of self-ignition during the expansion stroke as well as for detection of knocking. Alternatively, in the overlapping region of these sensing windows, ECU 20 may cease frequency analysis in the sensing window of the compression stroke, and only perform frequency analysis in the sensing window of the compression stroke to detect knocking and self-ignition in the compression stroke.

As another alternative, when the rotation speed of internal combustion engine 1 increases, ECU 20 may reduce the A/D conversion period (sampling period of voltage data) so as to limit the expansion of the angular regions of the sensing windows.

In the above-described embodiment, ECU 20 detects self-ignition during the compression stroke and self-ignition during the expansion stroke by using the self-ignition-specific frequency component obtained through frequency analysis on the detection signal of vibration sensor 27. However, alternatively, ECU 20 may detect self-ignition during the compression stroke and self-ignition during the expansion stroke based on the level of the retrieved voltage data (voltage level) obtained by A/D converting the detection signal of vibration sensor 27.

In other words, ECU 20 may detect self-ignition during the compression stroke and self-ignition during the expansion stroke based on the output level of vibration sensor 27, which is a characteristic value different from the knocking-specific frequency component to be used for knocking detection.

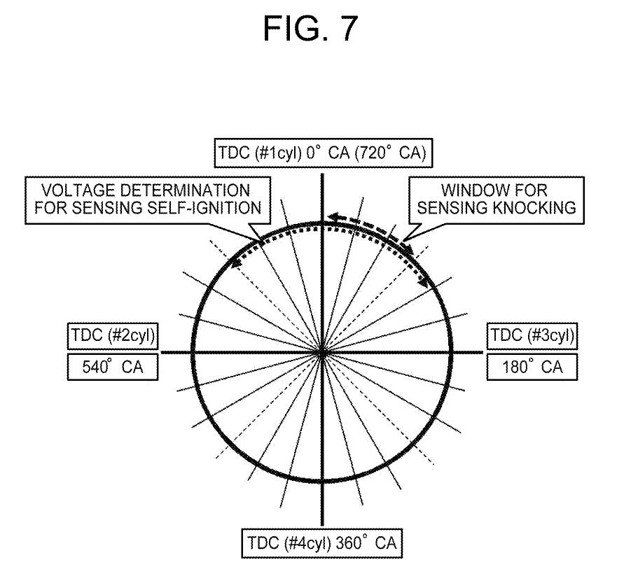

When detecting self-ignition based on the level of the voltage data, ECU 20 sets the sensing window for knocking during the expansion stroke to the region of 90 degrees by the crank angle immediately after the compression top dead center TDC (TDC to ATDC 90 degrees) as illustrated in FIG. 7. ECU 20 detects knocking through frequency analysis in this sensing window.

In addition, as illustrated in FIG. 7, ECU 20 sets a voltage determination region (abnormal fuel determination region) to a region extending over the compression stroke before ignition timing and the expansion stroke so as to include the sensing window for knocking. ECU 20 detects the presence or absence of self-ignition by comparing, with a voltage threshold value, the voltage data obtained by A/D converting the detection signal of vibration sensor 27 and retrieved in this voltage determination region.

Here, when the voltage data exceeds the voltage threshold value during the compression stroke, ECU 20 detects that preignition has occurred. When the voltage data exceeds the voltage threshold value during the expansion stroke and no knocking is detected through frequency analysis at substantially the same time, ECU 20 detects that self-ignition has occurred by considering the pressure vibration that exceeds the predetermined level is caused by the self-ignition.

In this case as well, ECU 20 is capable of individually detecting and distinguishing between self-ignition during the compression stroke, self-ignition during the expansion stroke, and knocking. Accordingly, when both self-ignition and knocking occur during the expansion stroke, ECU 20 is capable of individually sensing these occurrences to implement the countermeasure to self-ignition in parallel with the countermeasure to knocking.

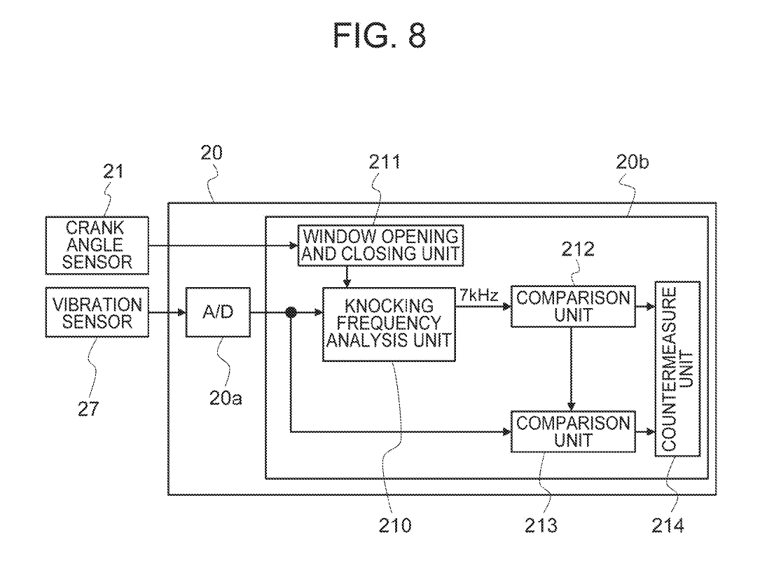

FIG. 8 is a functional block diagram of ECU 20 which detects knocking through frequency analysis, and detects self-ignition based on the sensor output level.

Microcomputer 20b internally included in ECU 20 has functions of a knocking frequency analysis unit 210, a sensing window opening and closing unit 211, a first comparison unit (knocking detection unit) 212, a second comparison unit (self-ignition detection unit) 213, and a countermeasure unit 214. Knocking frequency analysis unit 210 extracts the knocking-specific frequency component (component of 7 kHz) through frequency analysis on the output data from A/D converter 20a. Sensing window opening and closing unit 211 opens and closes the sensing window of the expansion stroke in which knocking frequency analysis unit 210 performs frequency analysis. First comparison unit (knocking detection unit) 212 compares the knocking-specific frequency component output from knocking frequency analysis unit 210 with the first threshold value, and outputs a signal indicating the presence or absence of knocking. Second comparison unit (self-ignition detection unit) 213 compares the output data (voltage value) from A/D converter 20a with the voltage threshold value and refers to the output from first comparison unit 212, thereby outputting the signal indicating the presence or absence of self-ignition. Countermeasure unit 214 implements the countermeasure to knocking and the countermeasure to self-ignition based on the output from first comparison unit 212 and the output from second comparison unit 213.

ECU 20 may detect self-ignition during the expansion stroke based on the self-ignition-specific frequency component calculated through frequency analysis in the sensing window set within the expansion stroke, and detect knocking based on the knocking-specific frequency component calculated through frequency analysis in the sensing window set within the expansion stroke. Also, ECU 20 may detect self-ignition during the compression stroke (preignition) by comparing, with the voltage threshold value, the voltage data obtained by A/D converting the detection signal of vibration sensor 27 and retrieved in the voltage determination region (abnormal combustion determination region) set within the compression stroke.

Here, enhancing detection sensitivity of ECU 20 for detecting knocking and self-ignition based on frequency components and for detecting self-ignition based on the sensor output level may possibly lead to false detection of knocking and/or self-ignition by confusing background noise during fuel injection or the like with occurrence of knocking and/or self-ignition.

ECU 20 may address this as follows. First, while operation conditions that presumably ensure no occurrence of knocking nor self-ignition are satisfied, that is, when, for example, internal combustion engine 1 operates in a low-load low-rotation region such as during engine idling, ECU 20 may detect a self-ignition-specific frequency component and a knocking-specific frequency component which are calculated through frequency analysis, and a sensor output level, and ECU 20 may learn these detected values as those for background noise. Then, ECU 20 may correct the threshold values based on the thus-learned background noise. Alternatively, ECU 20 may correct the extracted frequency components and/or the retrieved sensor output with correction values based on the learned values of background noise.

In other words, ECU 20 corrects the threshold values and/or the detected values (frequency component, sensor output) so as to reduce its detection sensitivity for knocking and self-ignition as the background noise increases.

ECU 20 can learn the corrected threshold values and the correction values for correcting the detected values (frequency component, sensor output) in each of the different operation conditions of internal combustion engine 1.

Here, as the sensing window for performing frequency analysis expands, the calculation load applied on ECU 20 increases. To avoid this, the sensing window may be reduced as follows. First, the initial sensing window, which is set large so as to incorporate a safety margin, may be subdivided into a plurality of windows. Then, among these subdivided windows, those that would be safe to exclude from the sensing window are learned based on detection history of knocking and self-ignition in each of the subdivided windows.

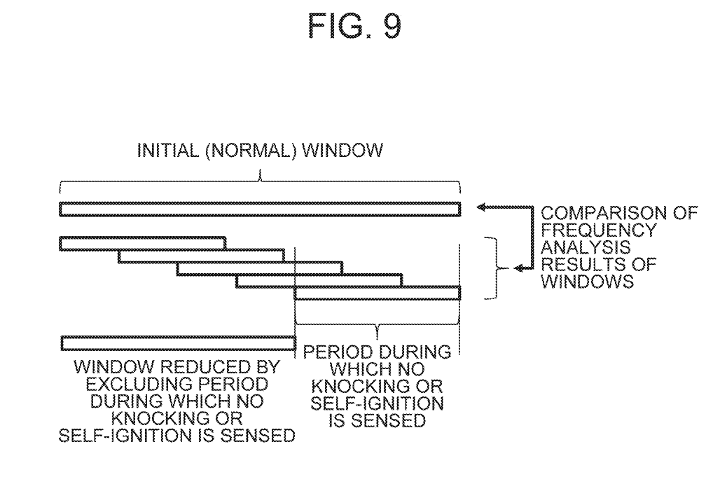

FIG. 9 is a diagram for describing learning for reducing the sensing window for performing frequency analysis.

In the initial settings, the sensing window of one cylinder is set, for example, to a region of 90 degrees of the crank angle that does not overlap the sensing window of another cylinder. In the example illustrated in FIG. 9, the sensing window is subdivided into windows such that each of the subdivided windows partially overlaps its previous and next subdivided windows.

Subsequently, among the plurality of subdivided windows, one or more subdivided windows in which neither the peak value of the self-ignition-specific frequency component nor the peak value of the knocking-specific frequency component are sensed are identified. Then, the sensing window is reduced by excluding the periods of the thus-identified subdivided windows from the sensing window.

The above learning for reducing the sensing window may be performed while the calculation load on microcomputer (CPU) 20b is small. This allows preventing the calculation load on ECU 20 from being excessively increased by learning. For example, the calculation load on microcomputer (CPU) 20b is small after completion of other learning processing (stopper position learning for electrically controlled throttle) when the rotation speed of internal combustion engine 1 is equal to or less than a predetermined speed.

Hereinabove, the details of the present invention have been specifically described with reference to the preferable embodiment. However, it is apparent for those skilled in the art that various modifications can be employed based on the essential technical concept and teachings of the present invention.

In the foregoing, internal combustion engine 1 includes variable compression ratio mechanism 100. However, it is apparent that the present invention can also be applied to an engine which does not include variable compression ratio mechanism 100.

Moreover, an alternative configuration may be employed in which fuel (octane value) to be injected to internal combustion engine 1 is changed as countermeasures to self-ignition and knocking.

Vibration sensor 27 is not limited to a non-resonant sensor, and a resonant sensor can be used instead.

Another alternative configuration may be employed in which the countermeasure to knocking is not set separately from the countermeasure to self-ignition, and the compression ratio is reduced when at least one of knocking and self-ignition occurs.

Internal combustion engine 1 is not limited to a four-cylinder engine. The present invention can be applied to various types of spark ignition engines.

Here, technical concepts which can be grasped from the above embodiments will be described below.

According to an aspect, a control device for an internal combustion engine which receives a detection signal of a vibration sensor for detecting pressure vibration in a combustion chamber of a spark ignition internal combustion engine, detects occurrence of knocking based on a knocking-specific frequency component of the detection signal in a knocking determination region, and detects occurrence of abnormal combustion based on a characteristic value, different from the knocking-specific frequency component, of the detection signal in an abnormal combustion determination region including the knocking determination region.

In a preferable aspect of the control device, the abnormal combustion determination region is set so as to extend over a compression stroke before ignition timing and an expansion stroke.

In another preferable aspect, the characteristic value of the detection signal to be used in the abnormal combustion detection is at least one of an output level of the detection signal of the vibration sensor, and an abnormal combustion-specific frequency component of the detection signal of the vibration sensor. Here, the abnormal combustion-specific frequency component has a frequency different from that of the knocking-specific frequency component.

Furthermore, in another preferable aspect, the control device detects occurrence of abnormal combustion based on the abnormal combustion-specific frequency component in a region, overlapping at least the knocking determination region, of the abnormal combustion determination region.

According to another aspect, there is provided an abnormal combustion detecting method for an internal combustion engine including: receiving a detection signal of a vibration sensor for detecting pressure vibration in a combustion chamber of a spark ignition internal combustion engine; extracting a knocking-specific frequency component from the detection signal in a knocking determination region within an expansion stroke; detecting occurrence of knocking based on the knocking-specific frequency component; detecting a characteristic value, different from the knocking-specific frequency component, of the detection signal in an abnormal combustion determination region including the knocking determination region that extends over a compression stroke before ignition timing and the expansion stroke; and detecting, as abnormal combustion, self-ignition during the compression stroke before ignition timing and self-ignition during the expansion stroke, based on the characteristic value.

### REFERENCE SYMBOL LIST

1 internal combustion engine
2 combustion chamber
9 fuel injection valve
10 spark plug
20 ECU
21 crank angle sensor
27 vibration sensor

1.-5. (canceled)

6. A control device for an internal combustion engine comprising:
detection means for receiving a detection signal of a vibration sensor for detecting pressure vibration in a combustion chamber of a spark ignition internal combustion engine, detecting occurrence of knocking based on a knocking-specific frequency component of the detection signal in a knocking determination region, and detecting occurrence of abnormal combustion based on a characteristic value, different from the knocking-specific frequency component, of the detection signal in an abnormal combustion determination region including the knocking determination region; and
determination region setting means for subdividing an initial region of the knocking determination region and the abnormal combustion determination region into a plurality of subdivided regions, setting a subdivided region to be excluded from the initial region based on detection history of knocking and abnormal combustion in each of the subdivided regions, and updating the knocking determination region and the abnormal combustion determination region in accordance with the setting.

7. The control device for an internal combustion engine according to claim 6, wherein the determination region setting means sets the subdivided regions such that each of the subdivided regions partially overlaps the previous and next subdivided regions thereof.

8. The control device for an internal combustion engine according to claim 6, wherein the determination region setting means excludes, among the subdivided regions obtained by subdividing the knocking determination region, a subdivided region in which a peak value of the knocking-specific frequency component is not detected, and excludes, among the subdivided regions obtained by subdividing the abnormal combustion determination region, a subdivided region in which a peak value of an abnormal combustion-specific frequency component is not detected.

9. The control device for an internal combustion engine according to claim 6, wherein the determination region setting means performs processing for updating the knocking determination region and the abnormal combustion determination region when a speed of the internal combustion engine is lower than a predetermined speed.

10. An abnormal combustion detecting method for an internal combustion engine comprising:
receiving a detection signal of a vibration sensor for detecting pressure vibration in a combustion chamber of a spark ignition internal combustion engine;
extracting a knocking-specific frequency component from the detection signal in a knocking determination region within an expansion stroke;
detecting occurrence of knocking based on the knocking-specific frequency component;
detecting a characteristic value, different from the knocking-specific frequency component, of the detection signal in an abnormal combustion determination region including the knocking determination region that extends over a compression stroke before ignition timing and the expansion stroke;
detecting, as abnormal combustion, self-ignition during the compression stroke before ignition timing and self-ignition during the expansion stroke, based on the characteristic value;
subdividing an initial region of the knocking determination region and the abnormal combustion determination region into a plurality of subdivided regions;
setting a subdivided region to be excluded from the initial region based on detection history of knocking and abnormal combustion in each of the subdivided regions; and
updating the knocking determination region and the abnormal combustion determination region in accordance with the setting.
